(19) United States
(12) Patent Application Publication
(10) Pub. No.: US 2014/0241689 A1
(43) Pub. Date: Aug. 28, 2014

(54) GANGED FIBER OPTIC CONNECTOR ADAPTER MODULES AND ASSEMBLIES HAVING REINFORCEMENT MEMBERS AND STAGGERED FIBER OPTIC CONNECTOR ADAPTER PORTS

(71) Applicant: Corning Cable Systems LLC, Hickory, NC (US)

(72) Inventors: Mark Alan Bradley, Hickory, NC (US); Micah Colen Isenhour, Lincolnton, NC (US); Dennis Michael Knecht, Hickory, NC (US); James Phillip Luther, Hickory, NC (US)

(73) Assignee: Corning Cable Systems LLC, Hickory, NC (US)

(21) Appl. No.: 13/795,888

(22) Filed: Mar. 12, 2013

Related U.S. Application Data
(60) Provisional application No. 61/770,677, filed on Feb. 28, 2013.

(51) Int. Cl. G02B 6/46

(52) U.S. Cl. CPC G02B 6/46
USPC 385/135

(57) ABSTRACT

Fiber optic connector adapter modules for use in optic communications networks are disclosed. In one embodiment, a fiber optic connector adapter module includes an adapter plate having a first surface and a second surface, an array of fiber optic connector adapters with a first port extending from the first surface of the adapter plate, wherein the first port of each fiber optic connector adapters of the array is configured to receive a first fiber optic connector, and at least one reinforcement member connecting the first port of adjacent fiber optic connector adapters of the array. In other embodiments, the first port of the fiber optic connector adapters are offset with respect to one another to provide better access to the first ports.

### RELATED APPLICATIONS

This application claims the benefit of priority under 35 U.S.C. § 119 of U.S. Provisional Application Ser. No. 61/770,677 filed on Feb. 28, 2013 the content of which is relied upon and incorporated herein by reference in its entirety.

### BACKGROUND

1. Field of the Disclosure

The technology of the present disclosure relates to fiber optic connector adapters and, more particularly, to ganged fiber optic connector adapters having reinforcement members between adjacent fiber optic connector adapter ports, as well as to fiber optic connector adapters having staggered fiber optic connector adapter ports.

2. Technical Background

Benefits of optical fiber include extremely wide bandwidth and low noise operation. Connectors are often used in cable management systems to provide service connections to rack-mounted equipment and to provide inter-rack connections. Typical connectors for mating fiber optics include two connectors that are joined by an adapter. As one example of a connector, an MPO-style connector is a multi-fiber connector suitable for high-density backplane and printed circuit board (PCB) applications for data and telecom systems. MPO-style connectors generally utilize adapters, which align the MPO-style connectors with other multi-fiber connectors for forming a connection therebetween.

Fiber optic communication systems, such as fiber optic local area networks (LAN), for example, commonly include fiber optic data center equipment, such as racks, frames, sub-frames, enclosures, and the like to provide for connection of a large number of connectorized optical fibers. Accordingly, fiber optic connector adapter modules allowing a large number of fiber optic connectors of optical cable assemblies to be connected to the communications network may be desired.

### SUMMARY OF THE DETAILED DESCRIPTION

Embodiments of the present disclosure are directed to ganged fiber optic connector adapters that allow multiple fiber optic connectors to be coupled to a communications network. More specifically, a fiber optic connector adapter module may include ganged multiple fiber optic connector adapters configured to mate with one or more fiber optic connector styles. The fiber optic connector adapter modules, which may be disposed in communications hardware, such as a data center enclosure, for example, may allow connection of a first fiber optic connector style to a second fiber optic connector style employed in the data center enclosure.

The fiber optic connector adapter modules described herein include reinforcement members between ports of adjacent fiber optic connector adapters to provide increased strength, and prevent deflection of the individual fiber optic connector adapter ports. In some embodiments, the fiber optic connector adapter ports are staggered to provide better access to the individual fiber optic connector adapter ports and the fiber optic connectors for technicians, as well to increase the receptacle density of the fiber optic connector adapter module.

In this regard, in one embodiment, a fiber optic connector adapter module includes an adapter plate having a first surface and a second surface, an array of fiber optic connector adapters each having a first port extending from the first surface of the adapter plate, wherein each first port of the array of fiber optic connector adapters is configured to receive a first fiber optic connector, and at least one reinforcement member connecting the first ports of adjacent fiber optic connector adapters of the array of fiber optic connector adapters.

In another embodiment, fiber optic connector adapter module includes an adapter plate having a first surface and a second surface, and an array of fiber optic connector adapters each with a first port extending from the first surface of the adapter plate. Each first port of the array of fiber optic connector adapters is configured to receive a first fiber optic connector, and each individual first port of the array of fiber optic connector adapters is offset from the first ports of adjacent fiber optic connector adapters along an insertion direction of the fiber optic connector.

In yet another embodiment, a fiber optic connector adapter module includes an adapter plate having a first surface and a second surface, first ports of an array of fiber optic connector adapters extending from the first surface of the adapter plate, and at least one reinforcement member connecting at least some adjacent first ports of the array of fiber optic connector adapters. Each first port of the array of fiber optic connector adapters is configured to receive a first fiber optic connector, and each individual first port of the array of fiber optic connector adapters is offset from adjacent first ports along an insertion direction of the fiber optic connector.

Additional features and advantages will be set forth in the detailed description which follows, and in part will be readily apparent to those skilled in the art from that description or recognized by practicing the embodiments as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

The components of the following figures are illustrated to emphasize the general principles of the present disclosure and are not necessarily drawn to scale. The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a front perspective view of an exemplary fiber optic connector adapter assembly comprising a plurality of fiber optic connector adapter modules comprising fiber optic connector adapters according to one or more embodiments described and illustrated herein;

FIG. 2A is a front perspective view of one of the plurality of fiber optic connector adapter modules of the exemplary fiber optic connector adapter assembly depicted in FIG. 1;

FIG. 2B is a rear perspective view of the fiber optic connector adapter module depicted in FIG. 2A;

FIG. 3A is a front perspective view of the fiber optic connector adapter module depicted in FIG. 2A further including a ferrule element;

FIG. 3B is a rear perspective view of the fiber optic connector adapter module depicted in FIG. 2B further including a ferrule element, a clip element, and a bias member;

FIG. 4 is a front perspective view of the fiber optic connector adapter module depicted in FIGS. 3A and 3B with fiber optic connectors coupled to the first ports of fiber optic connector adapters;

FIG. 5 is a front perspective view of a fiber optic connector adapter module having a single reinforcement member provided between the first ports of adjacent first fiber optic connector adapters according to one or more embodiments described and illustrated herein;

FIG. 6 is a front perspective view of an exemplary fiber optic connector assembly attached to an end of a fiber optic cable and configured to mate with a first port of the fiber optic connector adapter depicted in FIGS. 2A-3B;

FIG. 7 is a cross-sectional view of an individual fiber optic connector inserted into a port of an fiber optic connector adapter along with other fiber optic connectors inserted into a port of respective fiber optic connection adapters of a fiber optic connection adapter module;

FIG. 8 is a front perspective view of an exemplary fiber optic connector adapter module fiber optic connector adapter with staggered first and second ports according to one or more embodiments described and illustrated herein;

FIG. 9 is a side view of the fiber optic connector adapter module depicted in FIG. 8; and

FIG. 10 is a side perspective view of a plurality of fiber optic connectors each coupled to the first ports of respective fiber optic connector adapters depicted in FIGS. 8 and 9.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein; rather, these embodiments are provided so that this disclosure will satisfy applicable legal requirements. Whenever possible, like reference numbers will be used to refer to like components or parts.

Embodiments disclosed herein relate to fiber optic connector modules used in applications that include, but are not limited to, optical data center applications. More particularly, embodiments described herein include ganged fiber optic connector modules having multiple fiber optic connector adapters that provide ports of one or more styles to allow fiber optic connectors of optical cable assemblies to be optically coupled to a communications network via the data center enclosure. For example, each fiber optic connector module may include an array of MPO-style connector ports for receiving a plurality of optical cable assemblies having an MPO-style connector. It is noted that although embodiments are illustrated herein being directed to MPO-style connectors, embodiments are not limited thereto. The fiber optic connector adapter assemblies and modules described herein may be configured for other fiber optic connector styles.

As described in more detail below, reinforcement members are positioned between the ports of adjacent fiber optic connector adapters to increase the stiffness of the individual port and the overall strength of the fiber optic connector adapter module. The reinforcement members may reduce deflection of the individual ports due to the insertion of the fiber optic connectors into the fiber optic connector ports, as well as due to weight of the installed fiber optic connectors upon the fiber optic connector ports and torque applied to the connectors and/or fiber optic cables. In some embodiments, the ports of the fiber optic connector adapters may be staggered with respect to one other to provide for a high density fiber optic connector adapter module. The staggered ports of the fiber optic connector adapters may provide additional area for the fingers of personnel to access the various ports and the fiber optic connectors inserted therein.

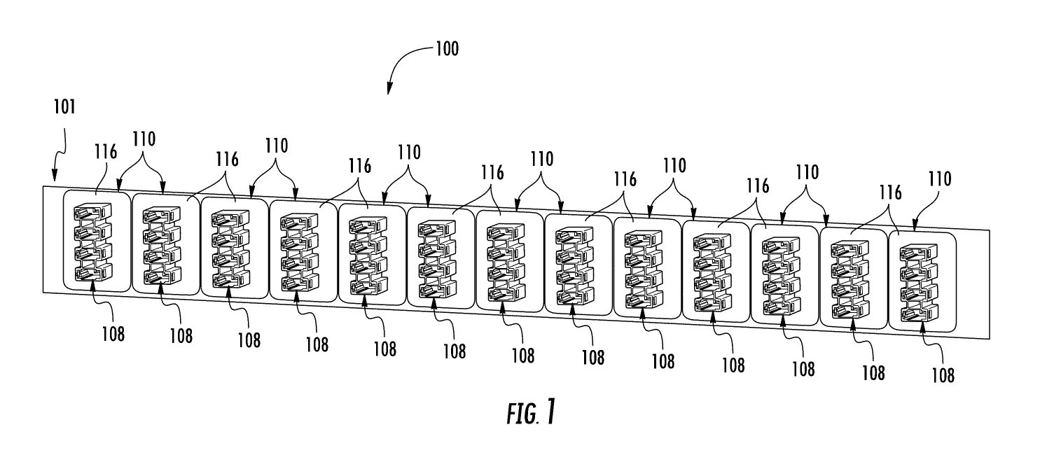

Referring now to FIG. 1, a fiber optic connector adapter assembly 100 according to one embodiment is illustrated. The fiber optic connector adapter assembly 100 generally includes a plurality of fiber optic connector adapter modules 110 installed in an adapter module mount 101. The fiber optic connector adapter modules 110 may be installed in the adapter module mount 101 by any appropriate method.

The adapter module mount 101 may be disposed in communications equipment, such as a data center enclosure (not shown), for example, to provide for optical connection of coupled optical cable assemblies to a data network (e.g., a local area network (“LAN”)). The fiber optic connector adapter modules 110, each of which has an array of fiber optic connector adapters 108 with first ports 111 and second ports 112, are retained within the adapter module mount 101. Each of the first ports 111 and the second ports 112 may be configured to be coupled to a fiber optic connector. In this way, the fiber optic connector adapters 108 may facilitate optical coupling between fiber optic connectors having the same or different configurations.

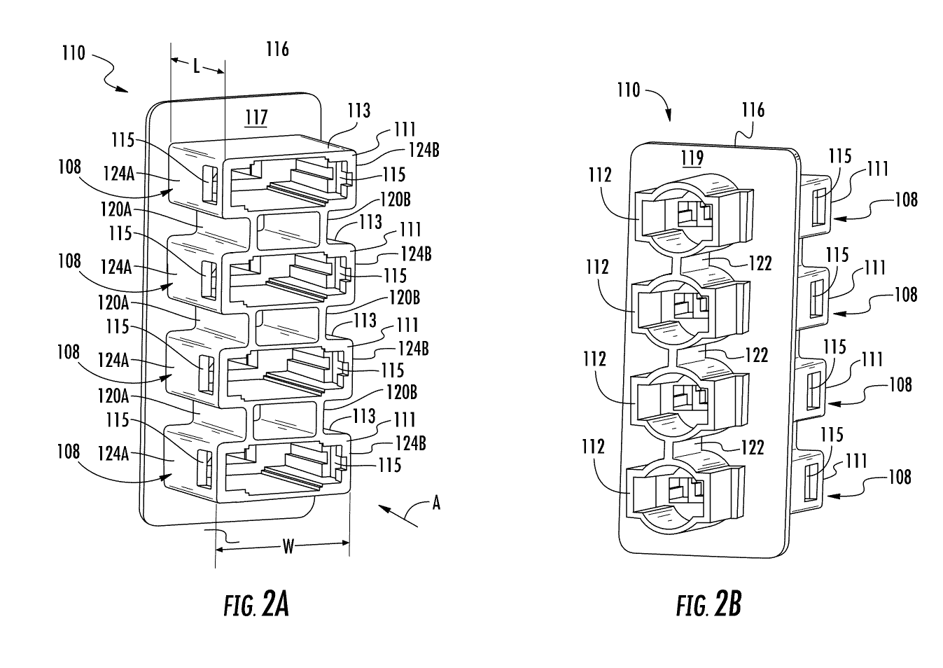

FIGS. 2A and 2B depict a first side and a second side of an exemplary fiber optic connector adapter module 110, respectively. The fiber optic connector adapter module 110, which may be fabricated from a rigid material, such as molded plastic, includes an array of fiber optic connector adapters 108. In the illustrated example, the first ports 111 of the array of fiber optic connector adapters 108 extend from a first surface 117 of an adapter plate 116 of the fiber optic connector adapter module 110, while the second ports 112 of the array of fiber optic connector adapters 108 extend from a second surface 119 of the adapter plate 116. The second surface 119 of the adapter plate 116 may contact a surface of the adapter module mount 101 as shown in FIG. 1, in some embodiments.

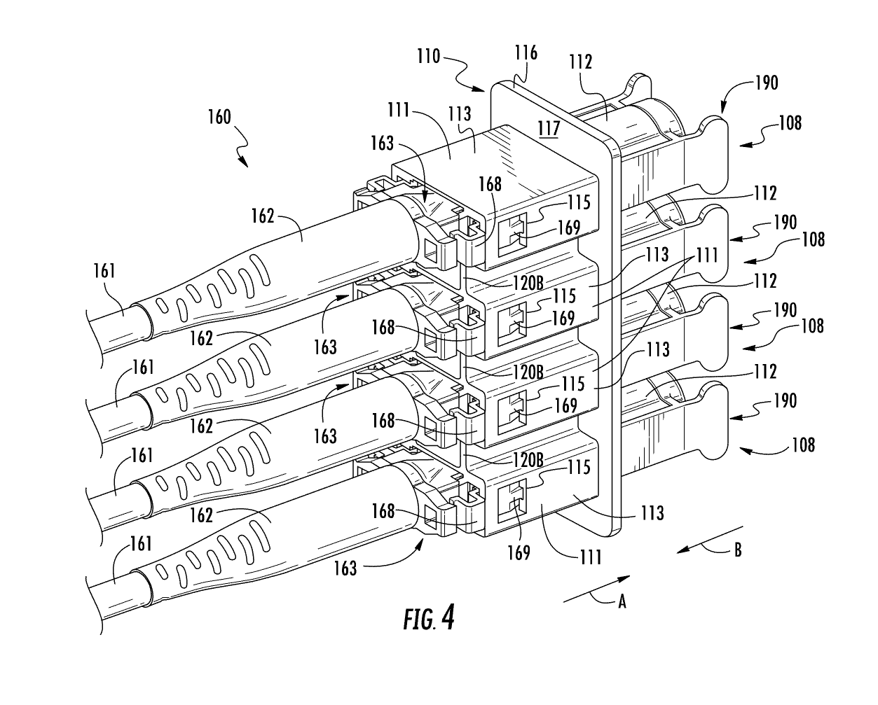

Referring first to FIG. 2A, the first ports 111 may have a body 113 that is shaped to form an opening configured to releasably receive an MPO-style fiber optic connector 163 (see FIGS. 4, 6 and 7). The body 113 of the illustrated embodiment includes openings 115 on each side to engage detents of 169 of locking arms 165A, 165B of a first fiber optic connector 163, as described in detail below. It should be understood that the first ports 111 may be configured to receive other fiber optic connector styles (e.g., SC or LC optical connectors). Although the illustrated fiber optic connector adapter module 110 is depicted as having four fiber optic connector adapters 108, embodiments are not limited thereto.

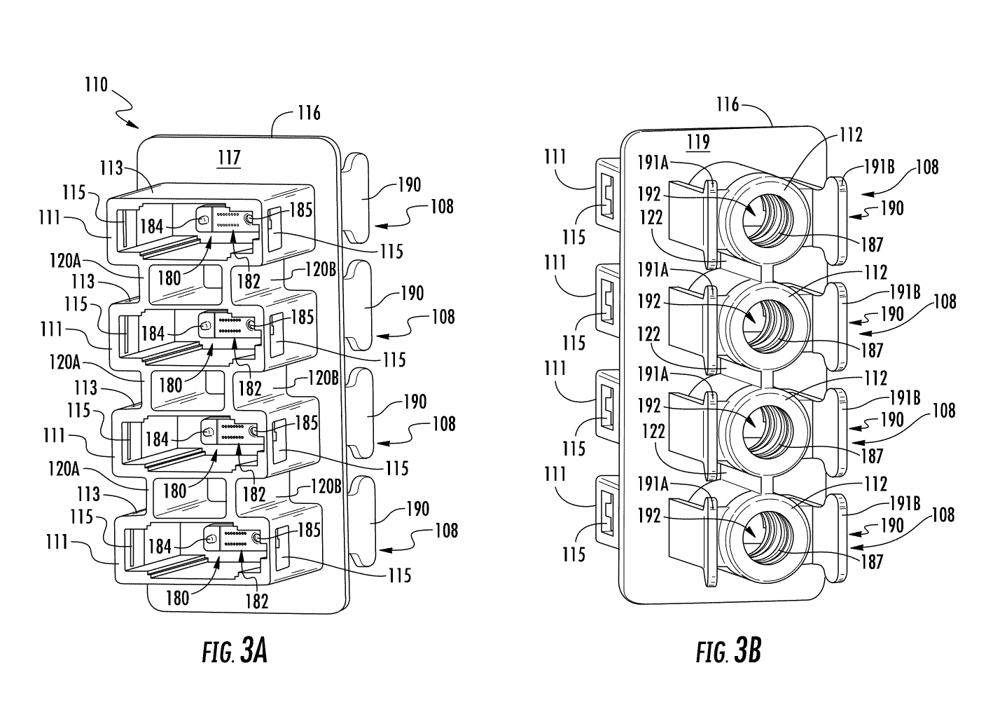

To increase the strength of the individual first ports 111, the fiber optic connector adapter modules 110 of the present disclosure may further include at least one reinforcement member (e.g., first and second reinforcement members 120A, 120B depicted in FIG. 3B) disposed between the first ports 111 of adjacent fiber optic connector adapters 108. The reinforcement members may minimize any deflection of the first ports 111, and therefore the amount of torque experienced by the first ports 111, under fiber optic cable assembly loads caused by coupled fiber optic connectors 163. For example, the reinforcement members described herein may minimize deflection caused by insertion of the first fiber optic connectors 163 into the first ports 111, as well as deflection caused by the weight of the installed fiber optic cable assemblies on the first ports 111 and torque applied to the fiber optic cable of the installed fiber optic cable assemblies. Any number of reinforcement members may be disposed between the first ports of adjacent fiber optic connector adapters 108.

In the illustrated embodiment, the first ports 111 of adjacent fiber optic connector adapters 108 are connected together by first and second reinforcement members 120A, 120B. The first and second reinforcement members 120A, 120B extend from the first surface 117 of the adapter plate 116 a full length L of the first ports 111. However, in alternative embodiments, the first and second reinforcement members 120A, 120B may not extend a full length L of the first ports 111 and/or not extend from the first surface 117 of the adapter plate (i.e., there is a gap between the first and second reinforcement members 120A, 120B and the first surface 117 of the adapter plate 116). In the illustrated embodiment, the first and second reinforcement members 120A, 120B are symmetrically positioned along a width w of the first ports 111 of adjacent fiber optic connector adapters 108. The reinforcement members described herein may be configured as a single component, or comprise individual segments (e.g., a first portion extending from an upper first port 111 and a second portion extending from a lower first port 111).

It should be understood that embodiments are not limited to the spacing and location of the first and second reinforcement members 120A, 120B depicted in FIG. 2A. For example, the first reinforcement member 120A may extend between the first edges 124A of first ports 111 adjacent fiber optic connector adapters 108, and the second reinforcement member 120B may extend between second edges 124B of first ports 111 of adjacent fiber optic connector adapters 108. The first and second reinforcement members 120A, 120B may also be angled with respect to one another in some embodiments. As an example and not a limitation, the first and second reinforcement members 120A, 120B may be angled at 45 degrees with respect to the first and second edges 124A, 124B of the first ports 111. In some embodiments, the first and second reinforcement members 120A, 120B may have crisscrossing members such that they have an “X” shape. Other configurations are also possible.

Referring now to FIG. 2B, the fiber optic connector adapter module 110 is illustrated showing second ports 112 of the array of fiber optic connector adapters 108. The second ports 112 oppose the first ports 111 to form a plurality of port pairs that define the fiber optic connector adapters 108. The second ports 112 may face the interior of the data center enclosure when the fiber optic connector adapter module 110 is installed in the adapter module mount 101 in such an enclosure, and be configured to receive a fiber optic connector that is to be coupled to the first fiber optic connector. It should be understood that the style of the second port 112 may be different from that depicted in FIG. 2B, and that the second port 112 may take on different connector configurations. Additionally, the second port 112 may be the same style or have the same configuration of the corresponding first port 111 of the port pair, or be a different style or have a different configuration from the corresponding first port 111 of the port pair. As shown in FIG. 2B, embodiments may also optionally include one or more reinforcement members 122 extending between second ports 112 of the adjacent fiber optic connector adapters 108. Embodiments are not limited to one reinforcement member 122 extending between second ports 112 of adjacent fiber optic connector adapters 108. The reinforcement members 122 between adjacent second ports 112 may be configured as described above with regard to the first and second reinforcement members 120A, 120B between adjacent first ports 111.

The fiber optic connector adapter module 110 may be fabricated from any suitably rigid material, such as metal or plastic. In embodiments, the fiber optic connector adapter module 110 is configured as a unitary component. In other words, the fiber optic connector adapter module 110 may be monolithic such that the features comprising the fiber optic connector adapter module 110, including, without limitation, the fiber optic connector adapters 108, the adapter plate 116 and the reinforcement members 120, 122 are made from one piece of material. For example, this material may be plastic and may be formed by injection molding.

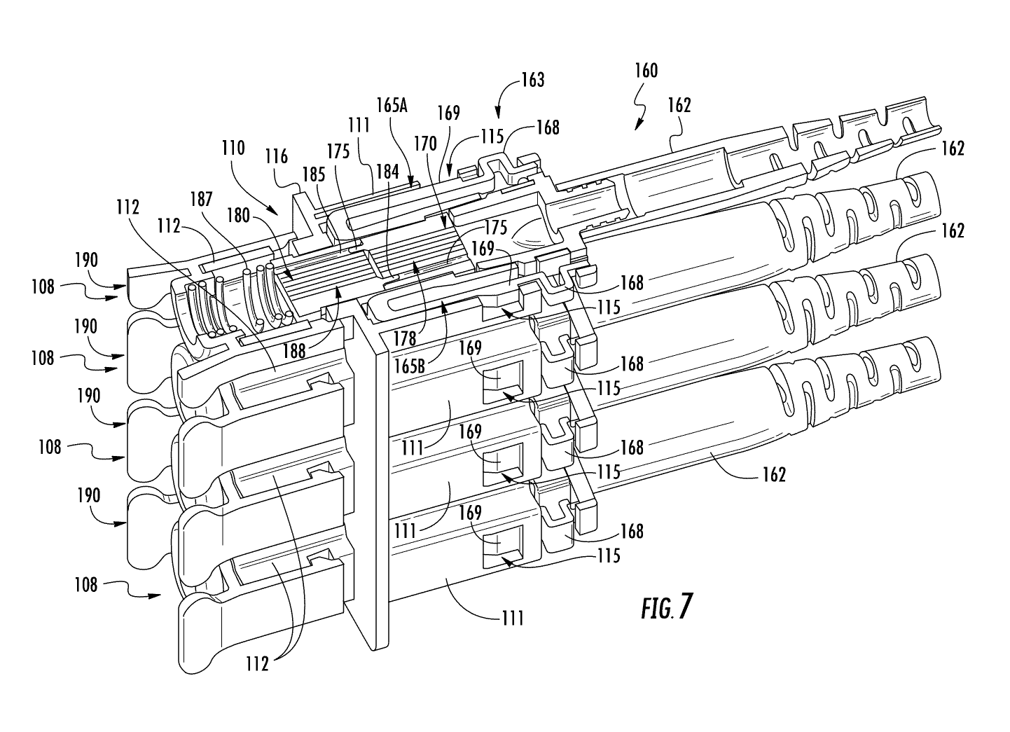

A ferrule element 180 may be disposed within each first port 111 of fiber optic connector adapters 108 (and/or second port 112 of fiber optic connector adapters 108), as shown in FIG. 3A, which depicts a fiber optic connector adapter module 110 populated with receptacle ferrule elements 180. The receptacle ferrule element 180 may take on a variety of configurations, and embodiments are not limited to the configuration of the ferrule assemblies depicted herein. As such, the ferrule element 180 is provided for illustrative purposes only. In the illustrated embodiment, the ferrule element 180 comprises an optical interface 182 that is defined by an array of lens elements, which are optically coupled to fiber optic components (not shown), such as optical fibers or waveguides extending toward a rear opening of the second fiber optic receptacle (see FIG. 7). The lens elements may be configured as refractive lenses, defractive lenses, gradient-index (“GRIN”) lenses and the like, and be positioned to be optically coupled to mated lenses of the fiber optic connector inserted into the first port 111. The optical interface 182 may be positioned at a rear end of the enclosure defined by the body 113 of the first port 111. As described below with respect to FIG. 7, the ferrule element 180 may be configured to translate within the first port 111 and/or the second port 112.

The illustrated receptacle ferrule element 180 includes mechanical coupling features that are configured to mate with corresponding mechanical coupling features of a ferrule element of a fiber optic connector 163. The exemplary mechanical coupling features of the illustrated embodiment comprise an alignment pin 184 and an alignment bore 185. The alignment pin 184 may be inserted into an alignment bore of the fiber optic connector 163, and the alignment bore may receive an alignment pin from the fiber optic connector 163.

FIG. 3B depicts the second surface 119 of the adapter plate 116 and populated second ports 112. As shown in FIG. 3B, a clip element 190 having a first arm 191A and a second arm 191B is attached to the body of the second ports 112. The first and second arms 191A and 191B may be compliant to remove the clip element 190 from the second ports 112. The illustrated clip element 190 includes an optical fiber opening 192 through which individual optical fibers (e.g., included in an optical cable or separately provided) may be disposed and coupled to the ferrule element 180.

As shown in FIG. 3B, a bias member 187 may be disposed within the second port 112 that biases the receptacle ferrule element 180 in a direction toward an opening of the first port 111. The receptacle ferrule element 180 may be disposed within the first and second ports 111, 112 such that is has freedom to move not only along directions parallel to the insertion direction A, but also move slightly in directions transverse to the insertion direction A.

FIG. 4_depicts the fiber optic connector adapter module depicted in FIGS. 3A and 3B with fiber optic connectors 163 coupled to the first ports of fiber optic connector adapter. The fiber optic connectors 163 are inserted into the first ports 111 of the fiber optic connector adapter 108 in a direction indicated by arrow A. Although not shown, second fiber optic connectors may be inserted into the corresponding second ports 112 of the fiber optic connector adapter 108 in a direction indicated by arrow B. As stated above, the first and second reinforcement members 120A, 120B may minimize any deflection of the first ports 111, and therefore the amount of torque experienced by the first ports 111, under fiber optic cable assembly loads caused by coupled fiber optic connectors 163.

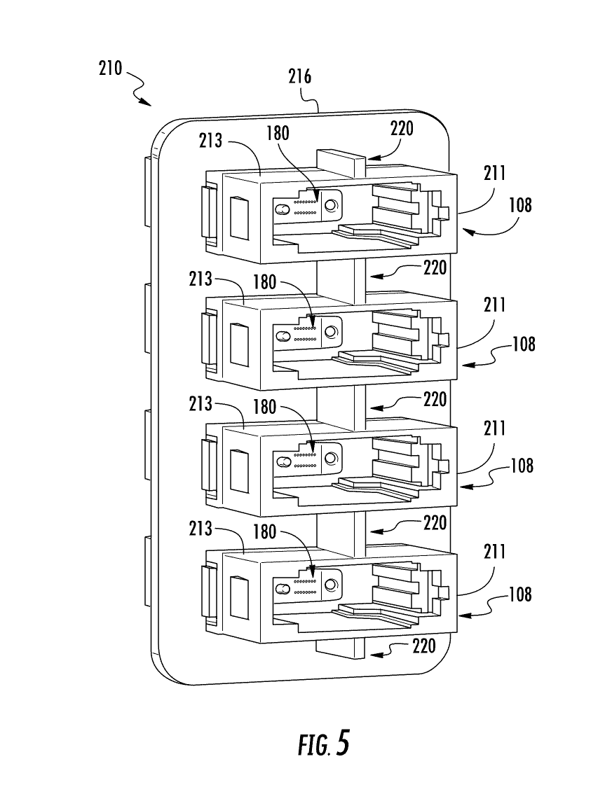

Referring now to FIG. 5, an alternative fiber optic connector adapter 210 having a single, centrally positioned reinforcement member 220 between adjacent first ports 211 of an array of fiber optic connector adapters 108 is shown. The centrally positioned reinforcement member 220 may strengthen the first ports 211 by minimizing deflection caused by insertion of the first fiber optic connectors 163 into the first ports 211, as well as deflection caused by the weight of the installed fiber optic cable assemblies on the first ports 211 and torque applied to the fiber optic cable of the installed fiber optic cable assemblies.

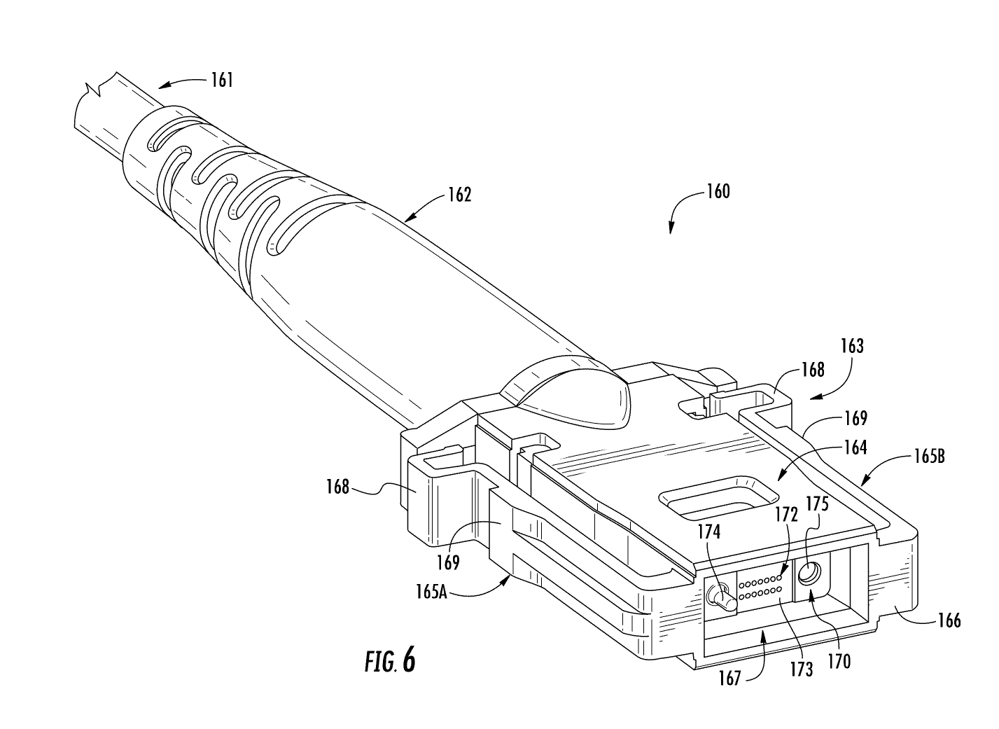

Referring now to FIG. 6, an exemplary fiber optic cable assembly 160 having a fiber optic connector 163 configured to be inserted into a first port 111 of one of the fiber optic connector adapters 108 of the fiber optic connector adapter module 110 is depicted. It should be understood that the fiber optic connector 163 is provided for illustrative purposes only, and that embodiments are not limited to any type or configuration of fiber optic connector. The fiber optic cable assembly 160 generally includes a fiber optic cable 161 that is coupled to a fiber optic connector 163 that is configured as a plug. The fiber optic cable 161 may include an outer jacket that surrounds and protects a plurality of optical fibers configured to optical transmission of optical signals. A strain relief element 162 may also be provided to protect the plurality of optical fibers from external forces applied to the fiber optic cable assembly 160. The fiber optic connector 163 generally comprises a plug body 164 that defines a ferrule enclosure into which a recessed ferrule element 170 is disposed (“plug ferrule element”). Having the plug ferrule element 170 recessed within the plug body 164 protects the lens elements of the plug ferrule element 170 from damage.

The plug ferrule element 170 is configured to optically and mechanically mate with a receptacle ferrule element 180 of the fiber optic connector adapter 108. In the illustrated, non-limiting example, the plug ferrule element 170 of the fiber optic connector 163 includes an optical interface 172 comprising an array of lens elements (which may be optically coupled to optical elements, such as optical fibers or waveguides). As described above, the lens elements may be configured as refractive lenses, defractive lenses, GRIN lenses, and the like. The plug ferrule element 170 further includes an alignment pin 174 and an alignment bore 175 configured to mate with the alignment bore 185 and the alignment pin 184 of the ferrule element 180 within the fiber optic connector adapter module 110, respectively.

The exemplary fiber optic connector 163 includes a plug body opening 167 at an insertion surface 166, which is the surface of the plug body 164 that is inserted into the first port 111. The plug body opening 167 is configured to receive the mated receptacle ferrule element 180 the fiber optic connector 163 is coupled to the first port 111.

In the illustrated embodiment, the plug body 164 comprises a first latching arm 165A and a second latching arm 165B that extend from the insertion surface 166 and are offset from a main portion of the plug body 164. Although two latching arms are depicted, it should be understood that more or fewer may be provided in alternative embodiments. The illustrated first and second latching arms 165A, 165B include a detent 169 that act as a locking mechanism that is configured to engage openings 115 of the first port 111 when the fiber optic connector 163 is inserted into the first port 111. The first and second latching arms 165A, 165B may include a release tab 168 at an end that is distal from the insertion surface 166. The first and second latching arms 165A, 165B are compliant in a direction transverse to the insertion direction upon application of force applied to the release tabs 168.

FIG. 7 depicts a cross-sectional view of the exemplary fiber optic connector 163 inserted into the first port 111 of one of the fiber optic connector adapters 108 of a fiber optic connector adapter module 110. Optical fibers are not shown in FIG. 7 for clarity and ease of illustration. The ferrule element 180 within the first port 111 in the illustrated embodiment is biased from an enclosure defined by the second port 112 toward an enclosure defined by the first port 111 by a bias member 187. The bias member 187 may be configured as a spring, for example. Accordingly, the receptacle ferrule element 180 may translate within the fiber optic connector adapter 108 upon insertion and removal of the fiber optic connector 163. The bias member 187 is maintained within the enclosure defined by the second port 112 by the clip element 190 in the illustrated embodiment. Other configurations are also possible.

The plug ferrule element 170 within the enclosure defined by the fiber optic connector 163 mates with the receptacle ferrule element 180 when the fiber optic connector 163 is inserted into the first port 111 in a direction indicated by arrow A. As shown in FIG. 5, the plug ferrule element 170 and the receptacle ferrule element 180 may each include fiber bores 178, 188 in which optical fibers (or waveguides and/or other optical components) may be disposed. The optical fibers (not shown) may terminate at the respective optical interface 172, 182, or terminate at some other optical components within the plug ferrule element 170 and the receptacle ferrule element 180 (e.g., GRIN lenses or waveguides).

The fiber optic connector 163 may be inserted into the first port 111 until the detents 169 of the first and second latching arms 165A, 165B are positioned in the openings 115 of the body 113 of the first port 111. The alignment pin 174 of the plug ferrule element 170 is inserted into the alignment bore 185 of the receptacle ferrule element 180, and the alignment pin 184 of the receptacle ferrule element 180 is inserted into the alignment bore 175 of the plug ferrule element 170. In this manner, the alignment pins 174, 184 and the alignment bores 175, 185 provide fine alignment of the lens elements of the two coupled optical interfaces 172, 182. The plug ferrule element 170 may push the receptacle ferrule element 180 along direction A such that the bias member 187 applies a force on the plug ferrule element 170 to maintain optical coupling between the optical interfaces 172, 182.

It should be understood that other connectors and coupling configurations may be provided, and that the embodiments depicted in at least FIGS. 4 and 5 are used merely as examples.

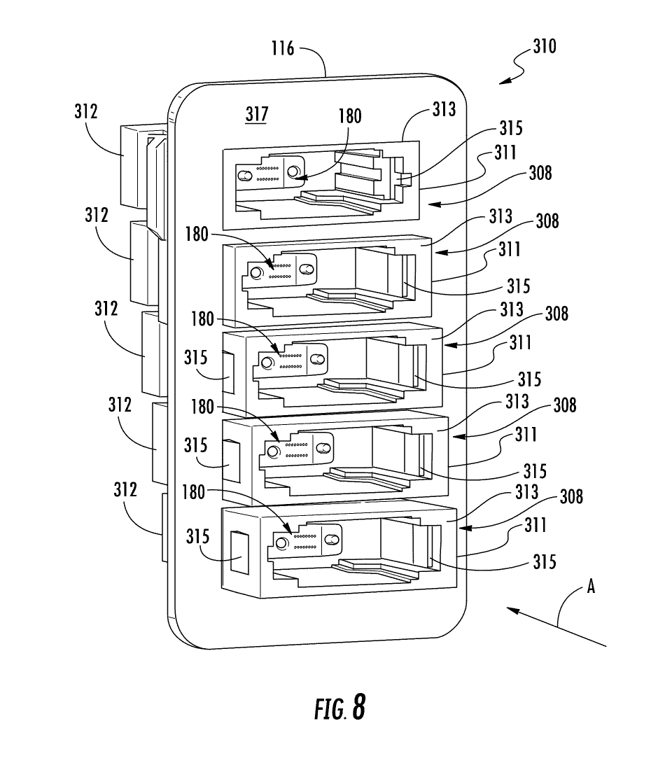

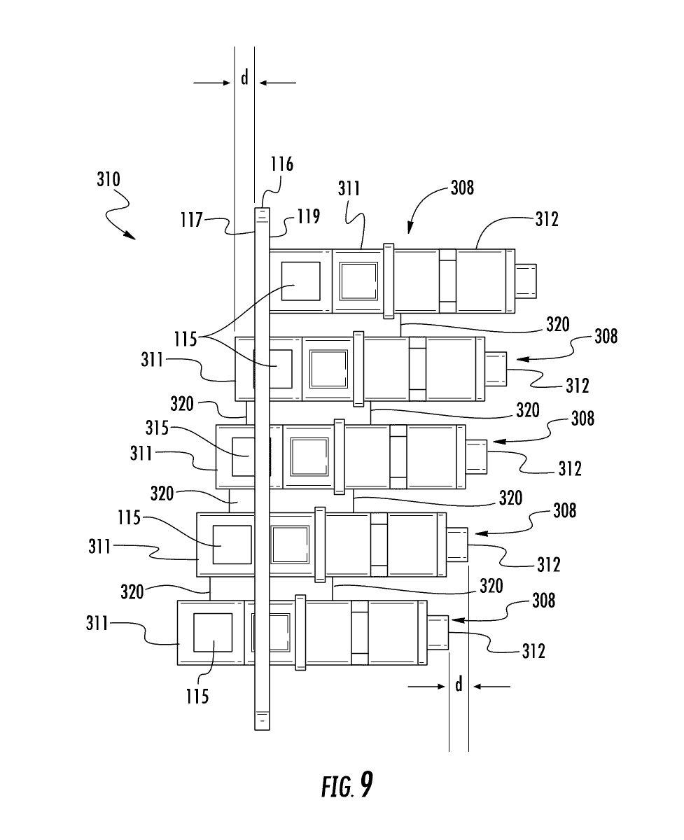

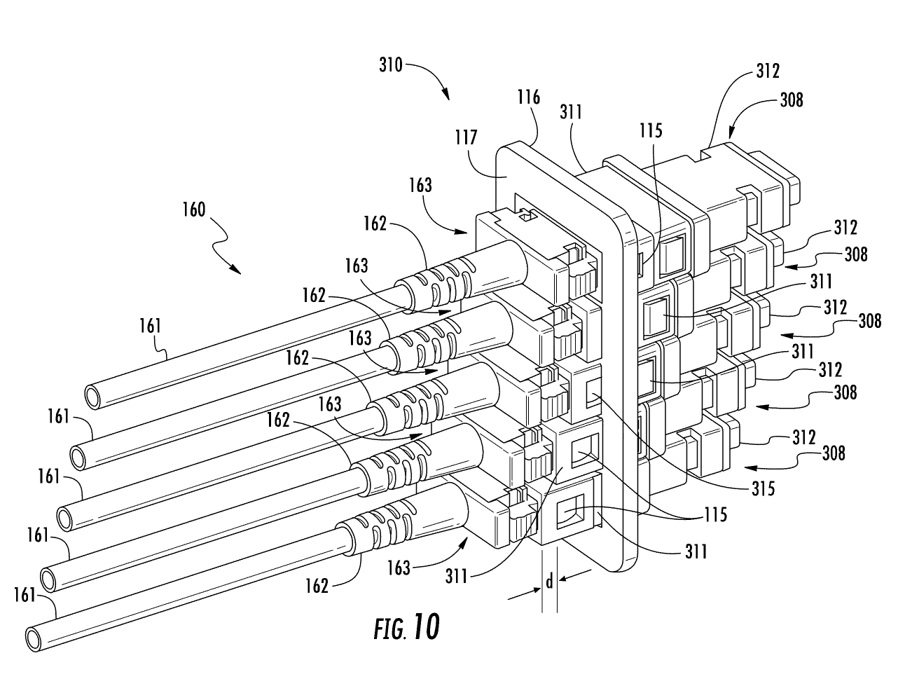

Referring now to FIGS. 8-10, a fiber optic connector adapter module 310 wherein the first ports 311 of the array of fiber optic connector adapters 308 are offset with respect to one another (i.e., staggered) is illustrated. FIG. 8 is a front perspective view of the fiber optic connector adapter module 310, FIG. 9 is a side view of the fiber optic connector adapter module 310 depicted in FIG. 8, and FIG. 10 is a perspective view of fiber optic connectors 163 of fiber optic cable assemblies 160 inserted into the first ports 311 of the fiber optic connector adapter module 310 depicted in FIG. 8. Such a staggered arrangement may provide for a more dense fiber optic connector adapter module 310 with an increased number of fiber optic connector adapters 308. More specifically, the staggered arrangement may provide increased volume per individual first port 311 for access by a field technician. In other words, the staggered arrangement may make it easier for a technician to insert and remove individual fiber optic connectors 163 from the fiber optic connector adapter module 310.

As shown in FIGS. 8-10, adjacent first ports 311, which include openings 315 for receiving a detent of a fiber optic connector, are offset with respect to one another by an offset distance d along an insertion direction A into which the fiber optic connectors 163 are inserted. The offset distance d should be large enough to provide access to the first ports 311 and the coupled fiber optic connectors 163. This may allow for a more dense fiber optic connector adapter module 310 with an increased number of first ports 311.

Referring specifically to FIGS. 9 and 10, the second ports 312 of adjacent fiber optic connector adapters 308 are also offset with respect to one another by the offset distance d, thereby also providing increased access to the second ports 312. It is noted that the second ports 312 are of a different configuration from the second ports 112 described above and illustrated in FIGS. 2B, 3B, 4 and 7).

In some embodiments, referring to FIG. 9, the staggered first ports 311 and/or the second ports 312 may also include reinforcement members 320 to increase the strength of the fiber optic connector adapter module 310, as described above. For example, the fiber optic connector adapter module 310 may include first and second reinforcement members disposed between adjacent first and/or second ports 311, 312 as depicted in FIGS. 2A and 3A, or a single reinforcement member as depicted in FIG. 5. It should be understood that more than two reinforcement members may be disposed between adjacent first and/or second ports 311, 312.

It should now be understood that embodiments of the present disclosure are directed to fiber optic connector adapter modules that may be installed in communications equipment, such as data center enclosures. The fiber optic connector adapter modules allow for fiber optic connectors of fiber optic cable assemblies to be coupled to a communications network. The fiber optic connector adapter modules described herein may increase the connector density by providing reinforcement members between ports of adjacent fiber optic connector adapters to increase the strength of the fiber optic connector adapter module. Additionally, in some embodiments, the individual ports of the fiber optic connector adapters may be staggered to provide better access to the individual ports and the coupled fiber optic connectors.

Many modifications and other embodiments of the embodiments set forth herein will come to mind to one skilled in the art to which the embodiments pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. It is intended that the embodiments cover the modifications and variations of the embodiments provided they come within the scope of the appended claims and their equivalents. Although specific terms are employed herein, they are used in a generic and descriptive sense only and not for purposes of limitation.

1. A fiber optic connector adapter module comprising:
an adapter plate comprising a first surface and a second surface;
an array of fiber optic connector adapters, wherein each of the fiber optic connector adapters of the array has a first port extending from the first surface of the adapter plate, wherein each first port is configured to receive a first fiber optic connector; and
at least one reinforcement member connecting first ports of adjacent fiber optic connector adapters of the array, and wherein the fiber optic connector adapter module is monolithic in that the adapter plate and the array of fiber optic connector adapters comprise a single, unitary piece of material.

2. The fiber optic connector adapter module of claim 1, wherein each at least one reinforcement member extends from the first surface of the adapter plate.

3. The fiber optic connector adapter module of claim 1, wherein:
the first port of each fiber optic connector adapter has a length; and
each at least one reinforcement member extends from the first surface of the adapter plate and has a length that is at least half of the length of the first port.

4. The fiber optic connector adapter module of claim 1, wherein each at least one reinforcement member comprises a single reinforcement member.

5. The fiber optic connector adapter module of claim 4, wherein each single reinforcement member is centrally positioned along a width of the first port of the array of fiber optic connector adapters.

6. The fiber optic connector adapter module of claim 5, wherein each single reinforcement member extends from the first surface of the adapter plate.

7. The fiber optic connector adapter module of claim 1, wherein each at least one reinforcement member comprises a first reinforcement member and a second reinforcement member.

8. The fiber optic connector adapter module of claim 7, wherein each first reinforcement member and each second reinforcement member extend from the first surface of the adapter plate.

9. The fiber optic connector adapter module of claim 1, wherein the each of the fiber optic connector adapters has a second port extending from the second surface of the adapter plate, wherein:
the second port of each fiber optic connector adapter of the is configured to receive a second fiber optic connector; and
the second ports of the fiber optic connector adapters of the array are aligned with the respective first ports, thereby defining port pairs.

10. The fiber optic connector adapter module of claim 9, further comprising at least one second reinforcement member connecting second ports of adjacent second fiber optic connector adapters.

11. The fiber optic connector adapter module of claim 9, wherein the first fiber optic connector is a different style from the second fiber optic connector.

12. The fiber optic connector adapter module of claim 9, wherein at least one of the first fiber optic connector and the second fiber optic connector is a multiple fiber connector.

13. The fiber optic connector adapter module of claim 1, wherein at least one of the first fiber optic connector and the second fiber optic connector is a single fiber connector.

14. The fiber optic connector adapter module of claim 1, wherein a ferrule element is disposed within each first port, the ferrule element comprising an optical interface, an alignment pin, and an alignment bore.

15. The fiber optic connector adapter module of claim 1, wherein each at least one reinforcement member comprise a first portion and a second portion.

16. The fiber optic connector adapter module of claim 1, wherein individual ones of the first ports of the array of fiber optic connector adapters are staggered with respect to one another along an insertion direction.

17. A fiber optic connector adapter module comprising:
an adapter plate comprising a first surface and a second surface;
an array of fiber optic connector adapters wherein each of the fiber optic connector adapters of the array has a first port extending from the first surface of the adapter plate, and wherein:
the first port of each fiber optic connector adapter of the array is configured to receive a first fiber optic connector; and
the first port of each individual fiber optic connector adapter of the array is offset from the first port of adjacent fiber optic connector adapters along an insertion direction of the fiber optic connector adapter, and wherein the fiber optic connector adapter module is monolithic in that the adapter plate and the array of fiber optic connector adapters comprise a single, unitary piece of material.

18. The fiber optic connector adapter module of claim 17, wherein at least one first port of the array of fiber optic connector adapters is substantially planar with respect to the first surface of the adapter plate.

19. The fiber optic connector adapter module of claim 17, wherein:
the first port of each fiber optic connector adapters of the array comprises a body, the body comprising a first opening on a first side and a second opening on a second side; and
the first opening and the second opening of the body are configured to receive a detent of a first latching arm and a second latching arm of an individual first fiber optic connector, respectively.

20. The fiber optic connector adapter of claim 17, wherein the array of fiber optic connector adapters comprises a second port extending from the second surface of the adapter plate, wherein:
the second port of each fiber optic connector adapter of the array is configured to receive a second fiber optic connector;
each individual second port of the array of fiber optic connector adapters is offset from the second ports of adjacent fiber optic connector adapters along the insertion direction of the fiber optic connector adapter; and
the second ports of the fiber optic connector adapters of the array are aligned with the respective first ports, thereby defining port pairs.

21. The fiber optic connector adapter of claim 20, wherein the port pairs are configured to optically couple the first fiber optic connector to the second fiber optic connector.

22. The fiber optic connector adapter module of claim 17, wherein a ferrule element is disposed within each first port, the ferrule element comprising an optical interface, an alignment pin, and an alignment bore.

23. A fiber optic connector adapter module comprising:
an adapter plate comprising a first surface and a second surface;
an array of fiber optic connector adapters each having a first port extending from the first surface of the adapter plate, wherein:
the first port of each first fiber optic connector adapters of the array is configured to receive a first fiber optic connector; and
each individual first port of the array of fiber optic connector adapters is offset from the first port of adjacent first fiber optic connector adapters along an insertion direction of the fiber optic connector adapter; and
at least one reinforcement member connecting at least some first ports of the adjacent first fiber optic connector adapters of the array.

24. The fiber optic connector adapter module of claim 23, wherein each at least one reinforcement member comprises a first reinforcement member and a second reinforcement member.

25. The fiber optic connector adapter module of claim 23, wherein the fiber optic connector adapters of the array comprises a second port extending from the second surface of the adapter plate, wherein:
each second port of the array of fiber optic connector adapters is configured to receive a second fiber optic connector;
each individual second port of the array of fiber optic connector adapters is offset from the second port of adjacent fiber optic connector adapters along the insertion direction of the fiber optic connector adapters; and
the second ports of the fiber optic connector adapters in the array are aligned with respective first ports thereby defining a port pairs.

26. The fiber optic connector adapter module of claim 25, further comprising at least one second reinforcement member connecting at least some second ports of adjacent fiber optic connector adapters of the array.

27. A fiber optic connector adapter assembly comprising:
an adapter module mount; and
a plurality of fiber optic adapter modules retained within the adapter module mount, each fiber optic adapter module comprising,
an adapter plate comprising a first surface and a second surface;
an array of fiber optic connector adapters, wherein each of the fiber optic connector adapters of the array has a first port extending from the first surface of the adapter plate, wherein each first port is configured to receive a first fiber optic connector; and
at least one reinforcement member connecting first ports of adjacent fiber optic connector adapters of the array, and wherein each fiber optic connector adapter module is monolithic in that the adapter plate and the array of fiber optic connector adapters comprise a single, unitary piece of material.
